(19) United States
(12) Patent Application Publication
(10) Pub. No.: US 2021/0253245 A1
(43) Pub. Date: Aug. 19, 2021

(54) METHOD AND DEVICE FOR REPORTING FLIGHT MODE AND METHOD AND DEVICE FOR CHANGING CONTROL STRATEGY

(71) Applicant: BEIJING XIAOMI MOBILE SOFTWARE CO., LTD., Beijing (CN)

(72) Inventor: Wei HONG, Beijing (CN)

(73) Assignee: BEIJING XIAOMI MOBILE SOFTWARE CO., LTD., Beijing (CN)

(21) Appl. No.: 17/251,877

(22) PCT Filed: Jun. 14, 2018
(86) PCT No.: PCT/CN2018/091283

§ 371 Date: Dec. 14, 2020

(51) Int. Cl. B64C 39/02; H04W 72/04; H04W 4/42; H04W 76/27; H04W 8/02

(52) U.S. Cl. CPC B64C 39/024; H04W 72/0413; B64C 2201/141; H04W 76/27; H04W 8/02; H04W 4/42

(57) ABSTRACT

A flight mode report method includes: when in a connected state, an unmanned aerial vehicle (UAV) changing a flight mode from a first mode to a second mode; and sending a flight mode change notification of the UAV to a base station to notify the base station that the flight mode of the UAV is changed from the first mode to the second mode, thereby providing conditions for the base station subsequently changing a control policy for the UAV in a timely manner.

### TECHNICAL FIELD

The present disclosure relates to the field of communication technology, and more particularly, to a method and a device for reporting a flight mode and a method and a device for changing a control strategy.

### BACKGROUND

An Unmanned Aerial Vehicle (UAV) is an unmanned aircraft operated by a radio remote control device and a self-contained program control device. The UAV is actually a general term for unmanned aircrafts. From a technical perspective, the UAV can be an unmanned fixed-wing aircraft, an unmanned vertical take-off and landing aircraft, an unmanned airship, an unmanned helicopter, an unmanned multi-rotor aircraft or an unmanned parawing aircraft and so on.

With the rapid development of the UAV technology, the cost of the UAV is reduced and the functions of the UAV are improved, the UAV is widely used in all aspects of life. At present, applications of UAV in the fields of aerial photography, agriculture, plant protection, miniature selfies, express transportation, disaster rescue, observation of wild animals, monitoring of infectious diseases, surveying and mapping, news reports, power inspections, disaster relief, film and television shooting, creating romance, etc. have greatly expanded the purpose of the UAV. Various countries are actively expanding industry applications and developing of the UAV technology.

In order to further expand the applications of the UAV, the 3rd Generation Partnership Project (3GPP) has passed the project of Enhanced Support for Aerial Vehicles, which aims for such research and standardization that the cellular network provide services that meet the demand for the UAV.

There are generally two modes for the UAV. One mode is a fixed mode, that is, an operator will plan a flight route of the UAV through a controller, so that the UAV can fly according to the planned route, and it is not necessary to control the UAV by the controller all the time. The other mode is a dynamic mode, that is, the operator will remotely control the UAV in real time through the controller. For the fixed mode, since the flight route and trajectory of the UAV are fixed, the cellular network can predict which base stations in the cellular network the UAV will pass through. In the actual flight process, the flight mode of the UAV may be changed. However, it is a technical problem to be solved how the base station knows the changed flight mode.

### SUMMARY

In view of this, the present disclosure provides a method and a device for reporting a flight mode, a method and a device for changing a control strategy, a UAV, a base station, and a computer-readable storage medium, so that when the flight mode is changed, the UAV in a fixed mode and in a connected state can report the changed flight mode to the base station in time, thus the base station can change the control strategy of the UAV in time.

According to a first aspect of the embodiments of the present disclosure, a method for reporting a flight mode applied to an unmanned aerial vehicle (UAV) in a first mode is provided. The method includes: when the UAV is in a connected state, changing the flight mode from the first mode to a second mode; sending a flight mode change notification of the UAV to a base station to notify the base station that the flight mode of the UAV is changed from the first mode to the second mode.

In an embodiment, the sending a flight mode change notification of the UAV to a base station includes: sending the flight mode change notification of the UAV to the base station through a media access control (MAC) control element (CE); or sending the flight mode change notification of the UAV to the base station through a radio resource control (RRC) signaling.

In an embodiment, the MAC CE includes a flight mode report MAC CE.

In an embodiment, the sending the flight mode change notification of the UAV to the base station through a RRC signaling includes: sending the flight mode change notification to the base station by setting a first information unit indicating the flight mode in a user equipment (UE) assistance information signaling to a first preset value; or adding a second information unit indicating the flight mode to the UE assistance information signaling, and sending the flight mode change notification to the base station by setting the newly added second information unit to a second preset value; or sending the flight mode change notification to the base station by setting a third information unit indicating the flight mode in a RRC connection reconfiguration completion signaling to a third preset value.

In an embodiment, when the first mode is a fixed mode, the second mode is a dynamic mode; or when the first mode is a dynamic mode, the second mode is a fixed mode.

According to a second aspect of the embodiments of the present disclosure, a method for changing a control strategy is applied to a base station. The method includes: receiving a flight mode change notification of a UAV reported by the UAV; determining that a flight mode of the UAV is changed from a first mode to a second mode according to the flight mode change notification; changing the control strategy of the UAV according to the change of the flight mode of the UAV from the first mode to the second mode.

In an embodiment, when the first mode is a fixed mode, the second mode is a dynamic mode; or when the first mode is a dynamic mode, the second mode is a fixed mode.

According to a third aspect of the embodiments of the present disclosure, a device for reporting a flight mode is applied to a UAV in a first mode, the device includes a mode changing module, configured to change the flight mode from the first mode to a second mode when the UAV is in a connected state; a sending module, configured to send a flight mode change notification of the UAV to a base station after the mode changing module changes the flight mode from the first mode to the second mode to notify the base station that the flight mode of the UAV is changed from the first mode to the second mode.

In an embodiment, the sending module includes: a first sending sub-module, configured to send the flight mode change notification of the UAV to the base station through a MAC CE; or a second sending sub-module, configured to send the flight mode change notification of the UAV to the base station through a RRC signaling.

In an embodiment, the MAC CE includes a flight mode report MAC CE.

In an embodiment, the second sending sub-module includes: a first sending unit, configured to send the flight mode change notification to the base station by setting a first information unit indicating the flight mode in a UE assistance information signaling to a first preset value; or a second sending unit, configured to add a second information unit indicating the flight mode to the UE assistance information signaling, and send the flight mode change notification to the base station by setting the newly added second information unit to a second preset value; or a third sending unit, configured to send the flight mode change notification to the base station by setting a third information unit indicating the flight mode in a RRC connection reconfiguration completion signaling to a third preset value.

In an embodiment, when the first mode is a fixed mode, the second mode is a dynamic mode; or when the first mode is a dynamic mode, the second mode is a fixed mode.

According to a fourth aspect of the embodiments of the present disclosure, a device for changing a control strategy is applied to a base station, the device includes: a receiving module, configured to receive a flight mode change notification of a UAV reported by the UAV; a determining module, configured to determine that a flight mode of the UAV is changed from a first mode to a second mode according to the flight mode change notification received by the receiving module; a changing module, configured to change the control strategy of the UAV according to the change of the flight mode of the UAV from the first mode to the second mode determined by the determination module.

In an embodiment, when the first mode is a fixed mode, the second mode is a dynamic mode; or when the first mode is a dynamic mode, the second mode is a fixed mode.

According to a fifth aspect of the embodiments of the present disclosure, a UAV, includes: a processor; and memory configured to store instructions executable by the processor, wherein, the processor is configured to: when the UAV is in a connected state, change a flight mode from a first mode to a second mode; send a flight mode change notification of the UAV to a base station to notify the base station that the flight mode of the UAV is changed from the first mode to the second mode.

According to a sixth aspect of the embodiments of the present disclosure, a base station includes: a processor; and memory configured to store instructions executable by the processor, wherein, the processor is configured to: receiving a flight mode change notification of a UAV reported by the UAV; determining that a flight mode of the UAV is changed from a first mode to a second mode according to the flight mode change notification; changing the control strategy of the UAV according to the change of the flight mode of the UAV from the first mode to the second mode.

According to a seventh aspect of the embodiments of the present disclosure, a non-transitory computer readable storage medium, having stored therein instructions that, when executed by a processor, to cause the processor to perform the method for reporting a flight mode.

According to an eighth aspect of the embodiments of the present disclosure, a non-transitory computer-readable storage medium having computer instructions stored thereon, executed by a processor, to cause the processor to perform the method for changing a control strategy.

The technical solutions provided by the embodiments of the present disclosure may include the following beneficial effects.

The flight mode is changed from the first mode to the second mode, and the flight mode change notification of the UAV is sent to the base station, so that the base station knows that the flight mode of the UAV is changed from the first mode to the second mode, thereby facilitating subsequent changes of control strategies of the UAV by the base stations in a timely manner.

It is determined that the flight mode of the UAV is changed from the first mode to the second mode according to the received flight mode change notification, so that the change of the flight mode from the first mode to the second mode is known in time, and the control strategy of the UAV can be changed accordingly.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1A is a flow chart showing a method for reporting a flight mode according to an embodiment of the present disclosure;

FIG. 1B is a schematic structural diagram showing a flight mode report MAC CE according to an embodiment of the present disclosure;

FIG. 2 is a flow chart showing a method for changing a control strategy according to an embodiment of the present disclosure;

FIG. 3 is a signaling flow chart showing a method for changing a control strategy according to an embodiment of the present disclosure;

FIG. 4 is a block diagram showing a device for reporting a flight mode according to an embodiment of the present disclosure;

FIG. 5 is a block diagram showing a device for reporting a flight mode according to another embodiment of the present disclosure;

FIG. 6 is a block diagram showing a device for reporting a flight mode according to still another embodiment of the present disclosure;

FIG. 7 is a block diagram showing a device for changing a control strategy according to an embodiment of the present disclosure;

FIG. 8 is a block diagram showing a device for reporting a flight mode according to an embodiment of the present disclosure;

FIG. 9 is a block diagram showing a device for changing a control strategy according to an embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of devices and methods consistent with aspects related to the disclosure as recited in the appended claims.

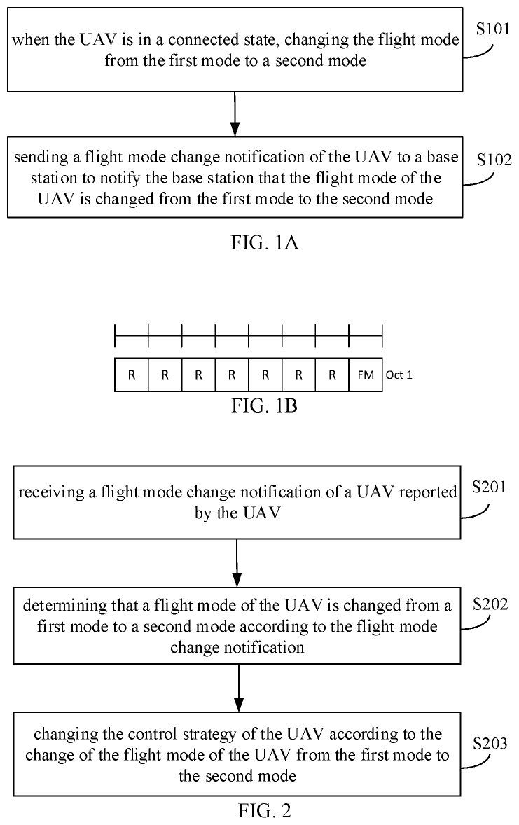

FIG. 1A is a flow chart showing a method for reporting a flight mode according to an embodiment of the present application. This embodiment is described from the UAV side in a first mode. As shown in FIG. 1A, the method for reporting a flight mode includes the following steps.

In step S101, when the UAV is in a connected state, the flight mode is changed from the first mode to a second mode.

When the first mode is a fixed mode, the second mode is a dynamic mode. When the first mode is a dynamic mode, the second mode is a fixed mode.

In step S102, a flight mode change notification of the UAV is sent to a base station to notify the base station that the flight mode of the UAV is changed from the first mode to the second mode.

The flight mode change notification of the UAV can be sent to the base station in various approaches. For example, the flight mode change notification of the UAV can be sent to the base station in the following approaches.

In approach 1, the flight mode change notification of the UAV is sent to the base station through a media access control (MAC) control element (CE).

The MAC CE may include a flight mode report MAC CE (FMR MAC CE). The format of FMR MAC CE can be shown in FIG. 1B, in which, R is a reserved bit and FM is used to indicate the flight mode. For example, when the value of FM is 1, it means that the flight mode is changed to the fixed mode, and when the value of FM is 0, it means that the flight mode is changed to the dynamic mode. The above values are only an example. In practical applications, it can be set flexibly.

In approach 2, the flight mode change notification of the UAV is sent to the base station through a radio resource control (RRC signaling).

The sending the flight mode change notification of the UAV to the base station through a RRC signaling can include the following approaches.

In approach 21, the flight mode change notification is sent to the base station by setting a first information unit indicating the flight mode in a UE assistance information (UEAssistanceInformation) signaling to the first preset value.

The first information unit is an existing information unit in the UEAssistanceInformation signaling, and the first preset value can be flexibly set according to needs, for example, a null value, or 0, or 1, etc.

For example, if the value of the first information unit is 1, it means that the flight mode of the UAV is changed to the dynamic mode, and if the value of the first information unit is 0, it means that the flight mode of the UAV is changed to the fixed mode.

In approach 22, a second information unit indicating the flight mode is added to the UEAssistanceInformation signaling, and the flight mode change notification is sent to the base station by setting the newly added second information unit to a second preset value.

The second information unit is not an existing information unit in the UEAssistanceInformation signaling, and the second preset value can be flexibly set according to needs, for example, a null value, or 0, or 1, etc.

For example, if the value of the second information unit is 1, it means that the flight mode of the UAV is changed to the dynamic mode. If the value of the second information unit is 0 or there is no second information unit in the UEAssistanceInformation signaling, it means that the flight mode of the UAV is changed to the fixed mode.

In approach 23, the flight mode change notification is sent to the base station by setting a third information unit indicating the flight mode in a RRC connection reconfiguration complete (ConnectionReconfigurationComplete) signaling to a third preset value.

The third preset value can be flexibly set according to needs, for example, a null value, or 0, or 1, etc.

For example, if the value of the third information unit is 1, it means that the flight mode of the UAV is changed to the dynamic mode, and if the value of the third information unit is 0, it means that the flight mode of the UAV is changed to the fixed mode.

It can be seen that in this embodiment, the flight mode change notification of the UAV can be sent to the base station through a variety of RRC signaling, the implementation methods are flexible and diverse.

In the above embodiment, the flight mode is changed from the first mode to the second mode, and the flight mode change notification of the UAV is sent to the base station, so that the base station knows that the UAV flight mode is changed from the first mode to the second mode, which provides conditions for the subsequent change on the control strategy of the UAV by the base station in time.

FIG. 2 is a flow chart showing a method for changing a control strategy according to an embodiment of the present disclosure. This embodiment is described from the UE side. As shown in FIG. 2, the method includes the following steps.

In step S201, a flight mode change notification of a UAV reported by the UAV is received.

In step S202, it is determined that a flight mode of the UAV is changed from a first mode to a second mode according to the flight mode change notification.

When the first mode is a fixed mode, the second mode is a dynamic mode. When the first mode is a dynamic mode, the second mode is a fixed mode.

In step S203, a control strategy of the UAV is changed according to the flight mode of the UAV that is changed from the first mode to the second mode.

For example, when the base station determines that the flight mode of the UAV is changed from the fixed mode to the dynamic mode, flight path information in the fixed mode may no longer be used as assistance information to improve the mobility of the UAV.

In the above embodiment, it is determined that the flight mode of the UAV is changed from the first mode to the second mode according to the flight mode change notification, it is possible to know in time that the flight mode is changed from the first mode to the second mode, and the control policy of the UAV may be changed accordingly.

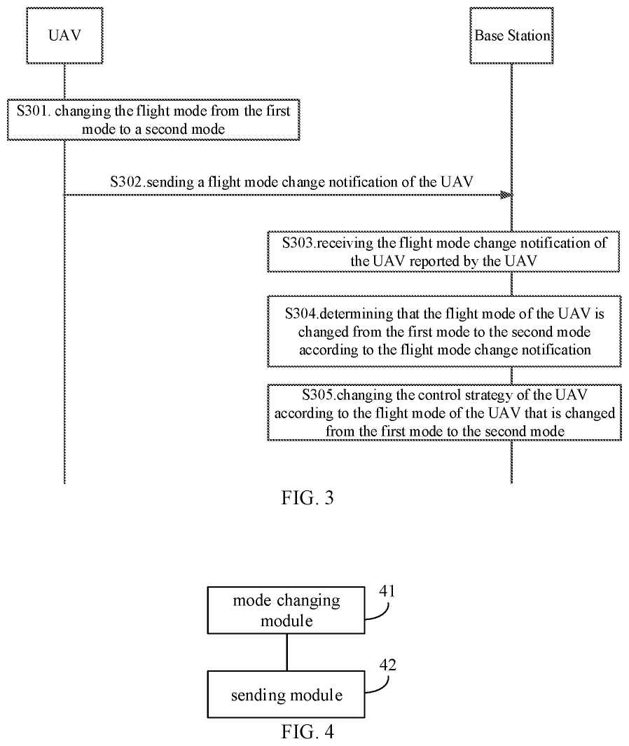

FIG. 3 is a signaling flow chart showing a method for changing a control policy according to an embodiment of the present disclosure. This embodiment is described from the perspective of interaction between a UAV and a base station. As shown in FIG. 3, the method includes the following steps.

In step S301, when the UAV is in a connected state, the UAV change the flight mode from the first mode to a second mode.

The first mode may be a fixed mode, and the second mode may be a dynamic mode.

In step S302, the UAV sends a flight mode change notification of the UAV to a base station.

In step S303, the base station receives the flight mode change notification of the UAV reported by the UAV.

In step S304, the base station determines that the flight mode of the UAV is changed from the first mode to the second mode according to the flight mode change notification.

In step S305, the base station changes the control strategy of the UAV according to the flight mode of the UAV that is changed from the first mode to the second mode.

In the above embodiment, through the interaction between the UAV and the base station, after the flight mode is changed from the first mode to the second mode, the flight mode change notification of the UAV is sent to the base station so that the base station can know that the flight mode of the UAV is changed from the first mode to the second mode, and the control strategy of the UAV can be changed in time.

FIG. 4 is a block diagram showing a device for reporting a flight mode according to an embodiment of the present disclosure. The device may be located in a UAV. As shown in FIG. 4, the device includes a mode changing module 41 and a sending module 42.

The mode changing module 41 is configured to change the flight mode from the first mode to the second mode when the UAV is in a connected state.

When the first mode is a fixed mode, the second mode is a dynamic mode. When the first mode is a dynamic mode, the second mode is a fixed mode.

The sending module 42 is configured to send a flight mode change notification of the UAV to the base station after the mode change module 41 changes the flight mode from the first mode to the second mode to notify the base station that the flight mode of the UAV is changed from the first mode to the second mode.

In the above embodiment, by changing the flight mode from the first mode to the second mode, and sending the flight mode change notification of the UAV to the base station, the base station know that the flight mode of the UAV is changed from the first mode to the second mode. This provides conditions for the subsequent change on the control strategy of the UAV by the base station in time.

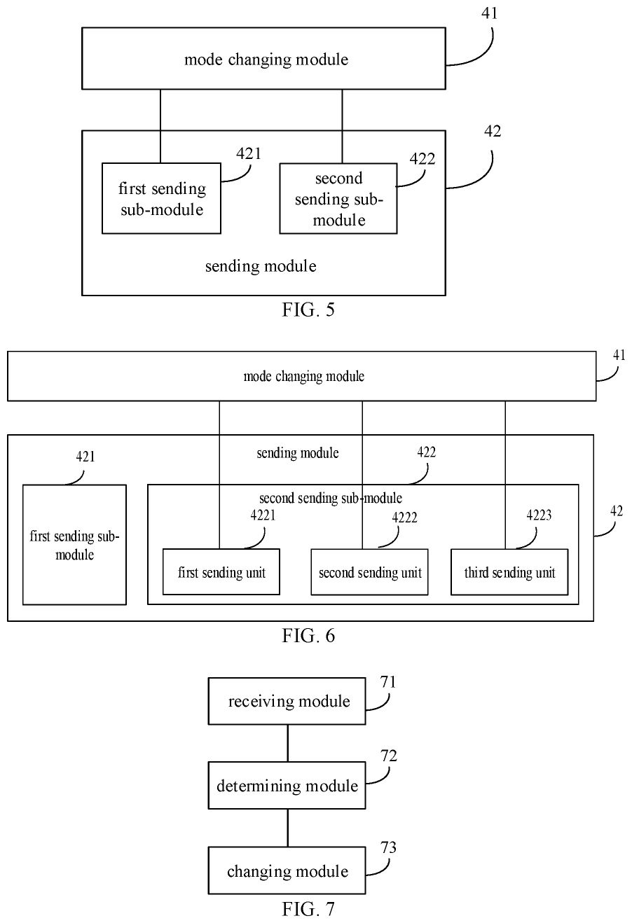

FIG. 5 is a block diagram showing a device for reporting the flight mode according to another embodiment of the present disclosure. As shown in FIG. 5, based on the embodiment shown in FIG. 4, the sending module 42 may include a sending sub-module 421 or a second sending sub-module 422.

The first sending sub-module 421 is configured to send the flight mode change notification of the UAV to the base station through a MAC CE.

The MAC CE may include an FMR MAC CE. The format of the FMR MAC CE can be shown in FIG. 1B, in which, R is a reserved bit and FM is used to indicate the flight mode. For example, when the value of FM is 1, it means that the flight mode is changed to a fixed mode, and when the value of FM is 0, it means that the flight mode is changed to a dynamic mode. The value of FM is only an example. In practical applications, it can be set flexibly.

The second sending sub-module 422 is configured to send the flight mode change notification of the UAV to the base station through a RRC signaling.

In the above embodiment, the flight mode change notification of the UAV can be sent to the base station in a variety of approaches, and the implementation methods are flexible and diverse.

FIG. 6 is a block diagram showing a device for reporting a flight mode according to another embodiment of the present disclosure. As shown in FIG. 6, based on the above-mentioned embodiment shown in FIG. 5, the second sending sub-module 422 may include a first sending unit 4221, a second sending unit 4222, or a third sending unit 4223.

The first sending unit 4221 is configured to send the flight mode change notification to the base station by setting a first information unit indicating the flight mode in UEAssistanceInformation signaling to a first preset value.

The first information unit is an existing information unit in the UEAssistanceInformation signaling, and the first preset value can be flexibly set according to needs, for example, a null value, or 0, or 1, etc.

For example, if the value of the first information unit is 1, it means that the flight mode of the UAV is changed to the dynamic mode, and if the value of the first information unit is 0, it means that the flight mode of the UAV is changed to the fixed mode.

The second sending unit 4222 is configured to add a second information unit indicating the flight mode to the UEAssistanceInformation signaling, and the flight mode change notification is sent to the base station by setting the newly added second information unit to a second preset value.

The second information unit is not an existing information unit in the UEAssistanceInformation signaling, and the second preset value can be flexibly set according to needs, for example, a null value, or 0, or 1, etc.

For example, if the value of the second information unit is 1, it means that the flight mode of the UAV is changed to the dynamic mode. If the value of the second information unit is 0 or there is no second information unit in the UEAssistanceInformation signaling, it means that the flight mode of the UAV is changed to the fixed mode.

The third sending unit 4223 is configured to send the flight mode change notification to the base station by setting a third information unit indicating the flight mode in a RRC connection reconfiguration complete (ConnectionReconfigurationComplete) signaling to a third preset value.

The third preset value can be flexibly set according to needs, for example, a null value, or 0, or 1, etc.

For example, if the value of the third information unit is 1, it means that the flight mode of the UAV is changed to the dynamic mode, and if the value of the third information unit is 0, it means that the flight mode of the UAV is changed to the fixed mode.

In the above-mentioned embodiment, the flight mode change notification of the UAV can be sent to the base station through various RRC signaling, the implementation methods are flexible and diverse.

FIG. 7 is a block diagram showing a device for changing a control strategy according to an embodiment of the present disclosure. The device may be located in a base station. As shown in FIG. 7, the device includes: a receiving module 71, a determining module 72, and a changing module 73.

The receiving module 71 is configured to receive a flight mode change notification of a UAV reported by the UAV.

The determining module 72 is configured to determine that a flight mode of the UAV is changed from a first mode to a second mode according to the flight mode change notification received by the receiving module 71.

When the first mode is a fixed mode, the second mode is a dynamic mode. When the first mode is a dynamic mode, the second mode is a fixed mode.

The changing module 73 is configured to change a control strategy of the UAV according to the change of the flight mode of the UAV from the first mode to the second mode determined by the determination module 72.

For example, when the base station determines that the flight mode of the UAV is changed from the fixed mode to the dynamic mode, flight path information in the fixed mode may no longer be used as assistance information to improve the mobility of the UAV.

In the above embodiment, it is determined that the flight mode of the UAV is changed from the first mode to the second mode according to the flight mode change notification, it is possible to know in time that the flight mode is changed from the first mode to the second mode, and the control policy of the UAV may be changed accordingly.

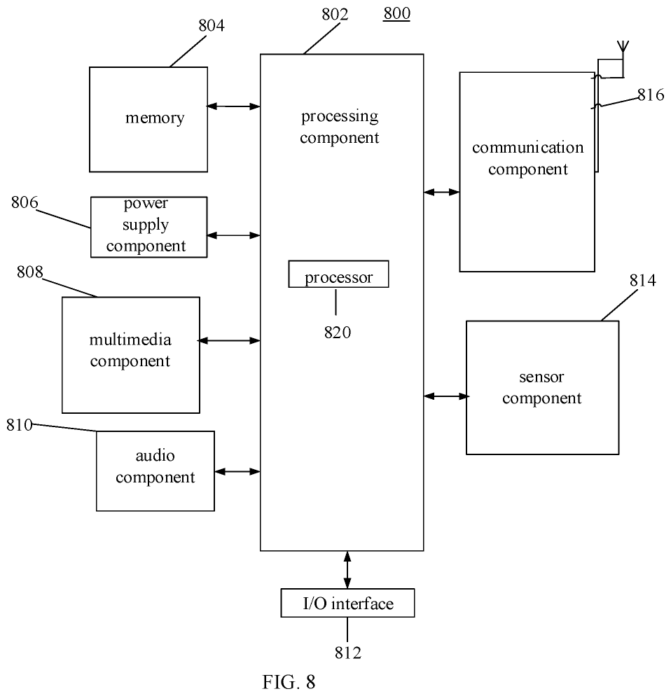

FIG. 8 is a block diagram showing a device for reporting a flight mode reporting according to an embodiment of the present disclosure. For example, the device 800 may be a mobile phone, a computer, a digital broadcasting terminal, a message transmission device, a game console, a tablet device, a medical device, a fitness device, a personal digital assistant, and other user equipment.

Referring to FIG. 8, the device 800 may include one or more of the following components: a processing component 802, memory 804, a power supply component 806, a multimedia component 808, an audio component 810, an input/output (I/O) interface 812, a sensor component 814, and a communication component 816.

The processing component 802 generally controls the overall operations of the device 800, such as operations associated with display, telephone calls, data communications, camera operations, and recording operations. The processing component 802 may include one or more processors 820 to execute instructions to implement all or part of the steps of the foregoing method. In addition, the processing component 802 may include one or more modules to facilitate the interaction between the processing component 802 and other components. For example, the processing component 802 may include a multimedia module to facilitate the interaction between the multimedia component 808 and the processing component 802.

One of the processors 820 in the processing component 802 may be configured to: when the VAV is in the connected state, change a flight mode from a first mode to a second mode; send a flight mode change notification of the UAV to the base station to notify the base station that the flight mode of the UAV is changed from the first mode to the second mode.

The memory 804 is configured to store various types of data to support the operation of the device 800. Examples of such data include instructions for any application or method executed by on the device 800, contact data, phone book data, messages, pictures, videos, etc. The memory 804 can be implemented by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 806 provides power to various components of the device 800. The power supply component 806 may include a power management system, one or more power supplies, and other components associated with the generation, management, and distribution of power for the device 800.

The multimedia component 808 includes a screen that provides an output interface between the device 800 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, sliding, and gestures on the touch panel. The touch sensor can not only sense the boundary of a touch or slide action, but also detect the duration and pressure related to the touch or slide operation. In some embodiments, the multimedia component 808 includes a front camera and/or a rear camera. When the device 800 is in an operation mode, such as a shooting mode or a video mode, the front camera and/or the rear camera can receive external multimedia data. Each front camera and rear camera can be a fixed optical lens system or have a focal length and optical zoom capabilities.

The audio component 810 is configured to output and/or input audio signals. For example, the audio component 810 includes a microphone (MIC). When the device 800 is in an operating mode, such as a call mode, a recording mode, and a voice recognition mode, the microphone is configured to receive external audio signals. The received audio signal may be further stored in the memory 804 or transmitted via the communication component 816. In some embodiments, the audio component 810 further includes a speaker for outputting audio signals.

The I/O interface 812 provides an interface between the processing component 802 and the peripheral interface module. The peripheral interface module may be a keyboard, a click wheel, a button, and so on. These buttons may include but are not limited to: a home button, a volume button, a start button, and a lock button.

The sensor component 814 includes one or more sensors for providing the device 800 with various aspects of state assessment. For example, the sensor component 814 can detect the on/off state of the device 800 and the relative positioning of components, such as the display and keypad of the device 800. The sensor component 814 can also detect the position change of the device 800 or a component of the device 800, whether a user contacts with the device 800, the orientation or acceleration/deceleration of the device 800, and the temperature change of the device 800. The sensor component 814 may include a proximity sensor configured to detect the presence of nearby objects when there is no physical contact. The sensor component 814 may also include a light sensor, such as a CMOS or CCD image sensor, for use in imaging applications. In some embodiments, the sensor component 814 may also include an acceleration sensor, a gyroscope sensor, a magnetic sensor, a pressure sensor or a temperature sensor.

The communication component 816 is configured to facilitate wired or wireless communication between the device 800 and other devices. The device 800 can access a wireless network based on a communication standard, such as Wi-Fi, 2G, or 3G, or a combination thereof. In an exemplary embodiment, the communication component 816 receives a broadcast signal or broadcast related information from an external broadcast management system via a broadcast channel. In an exemplary embodiment, the communication component 816 further includes a near field communication (NFC) module to facilitate short-range communication. For example, the NFC module can be implemented based on a radio frequency identification (RFID) technology, an infrared data association (IrDA) technology, an ultra-wideband (UWB) technology, a Bluetooth (BT) technology and other technologies.

In an exemplary embodiment, the device 800 may be implemented by one or more application specific integrated circuits (ASICs), digital signal processors (DSP), digital signal processing devices (DSPD), programmable logic devices (PLD), Field programmable gate array (FPGA), controller, microcontroller, microprocessor or other electronic components, so as to implement the above methods.

In an exemplary embodiment, there is also provided a non-transitory computer-readable storage medium including instructions, such as the memory 804 including instructions, which may be executed by the processor 820 of the device 800 to implement the foregoing method. For example, the non-transitory computer-readable storage medium may be a ROM, a random-access memory (RAM), a CD-ROM, a magnetic tape, a floppy disk, an optical data storage device, etc.

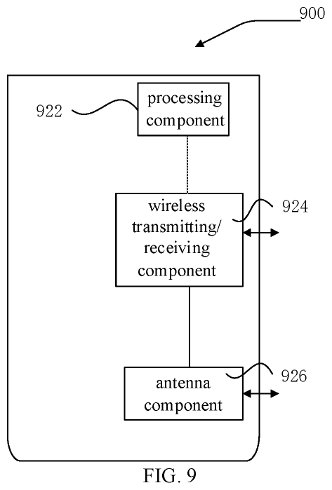

FIG. 9 is a block diagram showing a device for reporting the flight mode reporting according to another embodiment of the present disclosure. The device 900 may be provided as a base station. The device 900 includes a processing component 922, a wireless transmitting/receiving component 924, an antenna component 926, and a signal processing part dedicated to a wireless interface. The processing component 922 may further include one or more processors.

One of the processors in the processing component 922 may be configured to: receive a flight mode change notification reported by a UAV; determine that a flight mode of the UAV is changed from a first mode to a second mode according to the flight mode change notification; change the control strategy of the UAV according to the flight mode of the UAV that is changed from the first mode to the second mode.

In an exemplary embodiment, a non-transitory computer-readable storage medium including instructions is also provided, and the foregoing instructions can be executed by the processing component 1322 of the device 1300 to complete the foregoing method for changing the control strategy. For example, the non-transitory computer-readable storage medium may be a ROM, a random-access memory (RAM), a CD-ROM, a magnetic tape, a floppy disk, an optical data storage device, etc.

For the device embodiment, since it basically corresponds to the method embodiment, the part of the description of the method embodiment may be referred for related parts. The device embodiments described above are merely illustrative, in which, the units described as separate components may or may not be physically separated, and the units described as display components may or may not be physical units, that is, they may be located in one place, or distributed to multiple network units. Some or all of the modules may be selected according to actual needs to achieve the objectives of the solutions of the embodiments. A person skilled in the art can understand and implement it without creative work.

It should be noted that in this disclosure, relational terms such as first and second are only used to distinguish one entity or operation from another entity or operation, and do not necessarily require or imply that there is any such actual relationship or sequence between these entities or operations. The terms “include”, “comprise” or any other variants thereof are intended to cover non-exclusive inclusion, so that a process, method, article or device including a series of elements not only includes those elements, but also includes other elements not explicitly listed, or also include elements inherent to such processes, methods, articles, or device. If there are no more restrictions, the element defined by the sentence “including a . . . ” does not exclude the existence of other same elements in the process, method, article, or device including the element.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings and that various modifications and changes can be made without departing from the scope thereof. It is intended that the scope of the invention only be limited by the appended claims.

1. A method for reporting a flight mode, applicable to an unmanned aerial vehicle (UAV) in a first mode, comprising:
when the UAV is in a connected state, changing the flight mode from the first mode to a second mode;
sending a flight mode change notification of the UAV to a base station to notify the base station that the flight mode of the UAV is changed from the first mode to the second mode.

2. The method according to claim 1, wherein said sending the flight mode change notification of the UAV to the base station comprises:
sending the flight mode change notification of the UAV to the base station through a media access control (MAC) control element (CE); or
sending the flight mode change notification of the UAV to the base station through a radio resource control (RRC) signaling.

3. The method according to claim 2, wherein the MAC CE comprises a flight mode report MAC CE.

4. The method according to claim 2, wherein said sending the flight mode change notification of the UAV to the base station through the RRC signaling comprises:
sending the flight mode change notification to the base station by setting a first information unit indicating the flight mode in a user equipment (UE) assistance information signaling to a first preset value; or
adding a second information unit indicating the flight mode to the UE assistance information signaling, and sending the flight mode change notification to the base station by setting the newly added second information unit to a second preset value; or
sending the flight mode change notification to the base station by setting a third information unit indicating the flight mode in a RRC connection reconfiguration completion signaling to a third preset value.

5. The method according to claim 1, wherein
when the first mode is a fixed mode, the second mode is a dynamic mode; or
when the first mode is a dynamic mode, the second mode is a fixed mode.

6. A method for changing a control strategy, applicable to a base station, comprising:
receiving a flight mode change notification of an unmanned aerial vehicle (UAV) reported by the UAV;
determining that a flight mode of the UAV is changed from a first mode to a second mode according to the flight mode change notification;
changing the control strategy of the UAV according to the change of the flight mode of the UAV from the first mode to the second mode.

7. The method according to claim 6, wherein
when the first mode is a fixed mode, the second mode is a dynamic mode; or
when the first mode is a dynamic mode, the second mode is a fixed mode.

8.-14. (canceled)

15. An unmanned aerial vehicle (UAV), comprising:
a processor; and
memory configured to store instructions executable by the processor,
wherein, the processor is configured to:
when the UAV is in a connected state, change a flight mode from a first mode to a second mode;
send a flight mode change notification of the UAV to a base station to notify the base station that the flight mode of the UAV is changed from the first mode to the second mode.

16. A base station implementing the method of claim 6, comprising:
a processor; and
memory configured to store instructions executable by the processor,
wherein, the processor is configured to:
receive a flight mode change notification of the UAV reported by the UAV;
determine that a flight mode of the UAV is changed from a first mode to a second mode according to the flight mode change notification;
change the control strategy of the UAV according to the change of the flight mode of the UAV from the first mode to the second mode.

17. A non-transitory computer readable storage medium, having stored therein instructions that, when executed by a processor, to cause the processor to perform operations of the method according to claim 1.

18. A non-transitory computer-readable storage medium having computer instructions stored thereon that, when executed by a processor, to cause the processor to perform operations of the method according to claim 6.

19. The UAV according to claim 15, wherein the processor is further configured to:
send the flight mode change notification of the UAV to the base station through a media access control (MAC) control element (CE); or
send the flight mode change notification of the UAV to the base station through a radio resource control (RRC) signaling.

20. The UAV according to claim 19, wherein the MAC CE comprises a flight mode report MAC CE.

21. The UAV according to claim 19, wherein the processor is further configured to:
send the flight mode change notification to the base station by setting a first information unit indicating the flight mode in a user equipment (UE) assistance information signaling to a first preset value; or
add a second information unit indicating the flight mode to the UE assistance information signaling, and send the flight mode change notification to the base station by setting the newly added second information unit to a second preset value; or
send the flight mode change notification to the base station by setting a third information unit indicating the flight mode in a RRC connection reconfiguration completion signaling to a third preset value.

22. The UAV according to claim 15, wherein
when the first mode is a fixed mode, the second mode is a dynamic mode; or
when the first mode is a dynamic mode, the second mode is a fixed mode.

23. The UAV according to claim 22, wherein the UAV is configured to send the flight mode change notification of the UAV is sent to the base station, to thereby facilitate subsequent changes of control strategies of the UAV by the base stations in a timely manner.

24. The base station according to claim 16, wherein
when the first mode is a fixed mode, the second mode is a dynamic mode; or
when the first mode is a dynamic mode, the second mode is a fixed mode.

25. The base station according to claim 24, wherein the base station is configured to determine in real time that the flight mode of the UAV is changed from the first mode to the second mode according to the received flight mode change notification, to thereby change control strategies of the UAV accordingly.
